(19) United States
(12) Patent Application Publication
(10) Pub. No.: US 2007/0028271 A1
(43) Pub. Date: Feb. 1, 2007

(54) Apparatus for receiving digital multimedia broadcasting and method for outputting audio using the same

(75) Inventors: In-don Ju, Seoul (KR); Se-an Kwon, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/483,652

(22) Filed: Jul. 11, 2006

(30) Foreign Application Priority Data
Jul. 26, 2005 (KR) 2005-67994
Jul. 26, 2005 (KR) 2005-67996

(51) Int. Cl. H04N 7/173; H04N 7/16

(52) U.S. Cl. 725/62; 725/100; 725/131; 725/139

(57) ABSTRACT

An apparatus that receives digital multimedia broadcasting and an audio output method using the same are disclosed. The apparatus includes a receiving unit that receives a digital multimedia broadcasting signal; a processing unit that demodulates the received digital multimedia broadcasting signal; an interface unit that transfers the demodulated digital multimedia broadcasting signal to a main device, and receives an audio signal from the main device; and an audio output unit that outputs the received audio signal.

### CROSS-REFERENCE TO RELATED APPLICATIONS

This application claims all benefits accruing under 35 U.S.C. §119 from Korean Patent Application No. 10-2005-0067994 and 10-2005-0067996 filed on Jul. 26, 2005, in the Korean Intellectual Property Office, the disclosure of which is incorporated by reference herein.

### BACKGROUND OF THE INVENTION

1. Field of the Invention

The present invention relates generally to digital multimedia broadcasting, and more particularly, to an external apparatus for receiving digital multimedia broadcasting that enables a user to view digital multimedia broadcasting on a digital device that does not support the reception of digital multimedia broadcasts.

2. Related Art

Recent advancements in digital broadcasting technology and mobile communications infrastructure have enabled Digital Multimedia Broadcasting (hereinafter, referred to as “DMB”). DMB is a broadcasting service that enables a user to view various multimedia broadcasts over multiple channels using a mobile device such as a personal portable receiver or receiver for automobiles that can be used even while the user is moving.

In order to view DMB, the user must use a mobile device capable of receiving DMB signals. However, many mobile devices (e.g., conventional mobile phones, PDAs, and notebook computers) do not support DMB. As a result, separate DMB receivers have been developed and incorporated into these legacy mobile devices, to enable a user to view DMB on their mobile devices.

However, DMB receivers only receive a DMB signal, process it, and transfer it to the mobile device. The legacy mobile device must output the audio and video signal through its own display module and a speaker installed in the mobile device. Such a system is limited by the capabilities of the legacy device. If the mobile device has no embedded speaker, the user must use an earphone in order to listen to the DMB. If the mobile device has only one embedded speaker, the user cannot listen in stereo.

Moreover, when an external DMB receiver is connected to a non-DMB mobile device, power for the external DMB receiver is supplied by a battery of the mobile device. However, DMB reception requires a relatively large amount of power, significantly reducing the battery life of the mobile device.

Accordingly, there is a need for an external DMB receiver that enhances the audio capabilities and battery life of the main device.

### SUMMARY OF THE INVENTION

Several aspects and embodiments of the present invention provide a DMB receiver with audio capabilities and a supplemental battery.

Additional aspects and/or advantages of the invention will be set forth in part in the summary which follows and, in part, will be obvious from the summary, or may be learned by practice of the invention.

In accordance with an embodiment of the present invention, there is provided an apparatus for receiving digital multimedia broadcasting. Such an apparatus comprises: a receiving unit for receiving a digital multimedia broadcasting signal; a processing unit for demodulating the received digital multimedia broadcasting signal; an interface unit for transferring the demodulated digital multimedia broadcasting signal to a main device and receiving an audio signal from the main device; and an audio output unit for outputting the received audio signal.

In accordance with an aspect of the present invention there is provided a method of outputting audio by an apparatus for receiving digital multimedia broadcasting. Such method comprises: demodulating a received digital multimedia broadcasting signal; transferring the demodulated digital multimedia broadcasting signal to a main device; receiving an audio signal included in the digital multimedia broadcasting signal from the main device; and outputting the received audio signal.

In accordance with another embodiment of the present invention there is provided an apparatus for receiving digital multimedia broadcasting. The apparatus comprises: a receiving unit for receiving a digital multimedia broadcasting signal; a processing unit for demodulating the received digital multimedia broadcasting signal; an interface unit for transferring the demodulated digital multimedia broadcasting signal to a main device; and an extended power supply unit for supplying electrical power to the main device.

In accordance with an aspect of the present invention there is provided a system for receiving digital multimedia broadcasting. The system comprises: a digital multimedia broadcast receiver arranged to receive a broadcasting signal transmitted from a broadcast station; and a main device arranged to transfer an operation command input by a user to the digital multimedia broadcast receiver, and to receive and display the broadcasting signal received by the digital multimedia broadcast receiver, wherein the digital multimedia broadcast receiver includes a receiving unit having an antenna to receive the broadcasting signal; a processing unit to convert the broadcasting signal received by the receiving unit into a digital signal; and an extended power supply unit to supply electric power to the main device.

In accordance with an aspect of the present invention, there is provided an apparatus that receives digital multimedia broadcasting, comprising: a receiving unit for receiving a digital multimedia broadcasting signal; a processing unit for demodulating the received digital multimedia broadcasting signal; an interface unit for transferring the demodulated digital multimedia broadcasting signal to a main device and receiving an audio signal from the main device; an audio output unit for outputting the received audio signal; and an extended power supply unit for supplying electrical power to the main device.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a diagram illustrating a DMB receiver according to an embodiment of the present invention;

FIG. 2 is a block diagram illustrating a DMB receiver according to an embodiment of the present invention;

FIG. 3 is a block diagram illustrating the audio output unit of FIG. 2 in further detail;

FIG. 4 is a block diagram illustrating a main device according to an embodiment of the present invention;

FIG. 5 is a flowchart illustrating a method for processing an audio signal according to an embodiment of the present invention;

FIG. 6 is a block diagram illustrating a DMB receiver according to an embodiment of the present invention; and

FIG. 7 is a block diagram illustrating a main device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

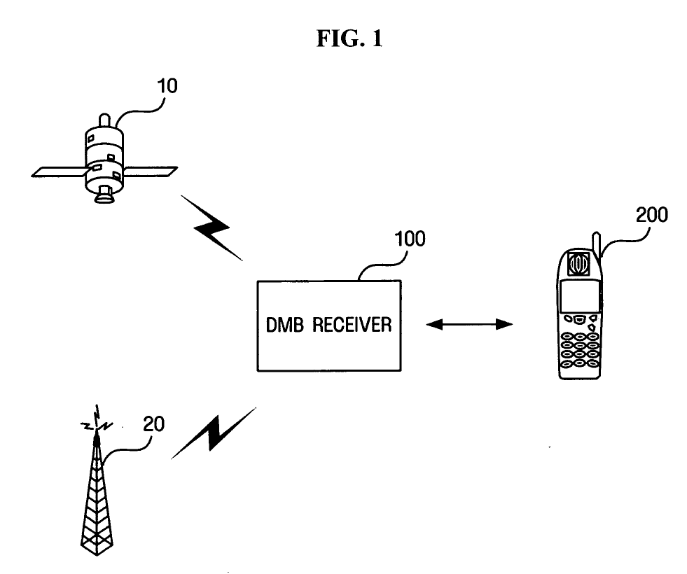

FIG. 1 illustrates a DMB receiver according to an embodiment of the present invention. As shown in FIG. 1, the DMB receiver 100 is a device that can receive a DMB signal and perform predetermined processing on the DMB signal. Such a DMB receiver also includes at least one speaker or battery or both, and can be connected to or disconnected from a main device 200. As used herein, the “connection” typically refers to a state in which the DMB receiver 100 and the main device 200 can communicate with each other through a wired medium, that is, an electrical connection. However, this preliminary definition does not cover the entire meaning of “connection,” which must be interpreted to include a state in which the DMB receiver 100 and the main device 200 can communicate with each other through a wireless medium connection.

The main device 200 is a device that can be connected to the DMB receiver 100, and can decode a digital signal sent from the DMB receiver 100, and output the decoded signal to the user. Although FIG. 1 shows a mobile phone as the main device 200, the present invention is not limited thereto; the main device 200 may be any type of mobile device such as, for example, a personal digital assistant (PDA) or a notebook computer.

When the main device 200 is connected to the DMB receiver 100, the DMB receiver 100 receives a DMB signal and transfers the received and processed DMB signal to the main device 200. The DMB signal received by the DMB receiver 100 may be a signal output from either a satellite 10 or a terrestrial base station 20.

The main device 200 extracts the video signal and audio signal from the DMB signal transferred from the DMB receiver 100, and decodes the video signal and audio signal. The decoded video signal may be displayed by a display module in the main device 200 to a user, and the audio signal is transferred back to the DMB receiver 100.

The DMB receiver 100 outputs the audio signal via one or more speakers mounted in the DMB receiver 100. Further, when the DMB receiver 100 is connected to the main device 200, a battery embedded in the DMB receiver 100 supplies power to the DMB receiver 100. In addition, the battery embedded in the DMB receiver 100 may also supply power to the main device 200 connected to the DMB receiver 100.

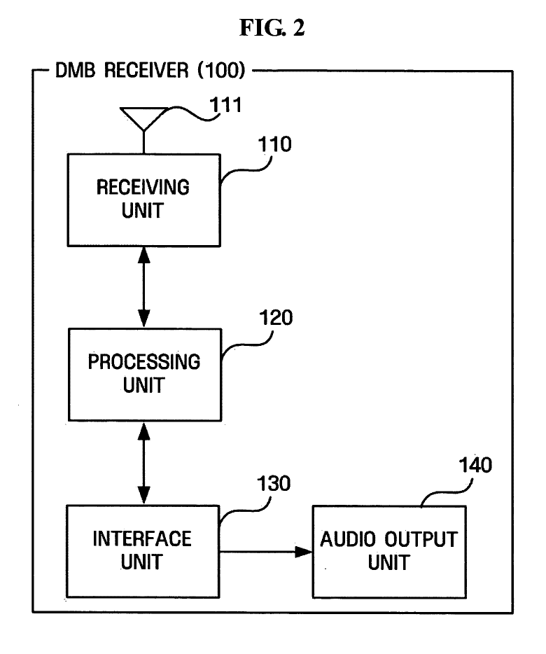

FIG. 2 is a block diagram illustrating a DMB receiver according to an embodiment of the present invention. As shown in FIG. 2 the DMB receiver 100 comprises a receiving unit 110, a processing unit 120, an interface unit 130, and an audio output unit 140.

The receiving unit 110 receives a DMB signal. For this purpose, the receiving unit 110 may include an antenna 111. The DMB signal will include, but is not limited to, at least one of video data, audio data, or additional information data, which are divided into transmission packets each having a predetermined unit size. The video data and audio data may be data compressed by a video compression scheme such as MPEG4 or an audio compression scheme such as MP3, and the additional information data may include caption data in relation to the video data or audio data, other broadcasting information, and others.

The receiving unit 110 performs predetermined signal processing jobs for the received DMB signal. For example, because the DMB signal is a kind of RF (Radio Frequency) signal, the receiving unit 110 may convert the RF signal to an Intermediate Frequency (IF) signal having a lower frequency, extract a baseband signal from the IF signal, and then transmit the baseband signal to the processing unit 120. However, the present invention is not limited to such a construction, and the receiving unit 110 may instead perform direction conversion between the RF signal and the baseband signal according to a direct conversion scheme (referred to also as the “Zero IF scheme”).

Further, the receiving unit 110 may receive a predetermined control signal from the processing unit 120 and perform a channel tuning operation.

The processing unit 120 demodulates the DMB signal received by the receiving unit 110. For example, the processing unit 120 may perform filtering and waveform shaping on the baseband signal that the processing unit 120 received from the receiving unit 110. Specifically, the processing unit 120 may perform analog/digital conversion of the signal from the receiving unit 110, perform Quadrature Phase Shift Keying (QPSK) of the signal, and perform error correction for the signal according to a Forward Error Correction (FEC) scheme. However, the present invention is not limited to such a construction, and other signal processing may be performed by the processing unit 120.

Further, if the processing unit 120 has received a control signal for the channel tuning from the main device 200 via the interface unit 130, the processing unit 120 transfers the control signal to the receiving unit 110.

The interface unit 130 is connected to the main device 200 and transfers the DMB signal demodulated by the processing unit 120 to the main device 200. Further, the interface unit 130 may receive a control signal for the channel tuning or an audio signal from the main device 200. For this purpose, the interface unit 130 includes multiple signal transfer nodes for DMB signal transfer, control signal reception, or audio signal reception. The interface unit 130 may further include a sensor unit (not shown) for detecting connection with the main device 200 when the interface unit 130 is connected to the main device 200. When the sensor unit detects the connection with the main device 200, the interface unit 130 may transmit a signal reporting the connection to the main device 200.

The audio output unit 140 outputs an audio signal received from the main device 200 to the user. To this end, the audio output unit 140 includes a speaker, preferably at least two speakers for stereo broadcasting. The audio output unit 140 may also include a woofer.

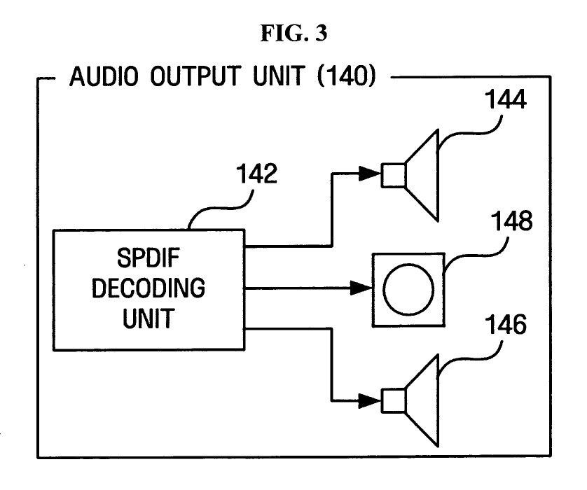

When the main device 200 transmits an audio signal by using a Sony/Philips Digital Interface (hereinafter SPDIF) signal, the audio output unit 140 may also include an SPDIF decoding unit for processing of such a signal. The audio output unit 140 having such a construction is shown in detail in FIG. 3.

As shown in FIG. 3, the audio output unit 140 comprises speakers 144 and 146 and an SPDIF decoding unit 142. The SPDIF decoding unit 142 generates left/right audio signals and a low tone audio signal by decoding the SPDIF signal transmitted through the interface unit 130 from the main device 200 and then transmits the generated signals to the speakers 144 and 146 and the woofer 148. The speakers 144 and 146 and the woofer 148 can output the audio signals from the SPDIF decoding unit 142 to the user.

Although the audio output unit 140 includes two speakers 144 and 146 in the present embodiment, the present invention is not limited thereto and the audio output unit 140 may include one or more speakers. In addition, a SPDIF decoding unit 142 is shown in the present embodiment, but the present invention is not limited thereto. For example, the audio output unit may include any type of decoding unit necessary to process the audio signal from the main device.

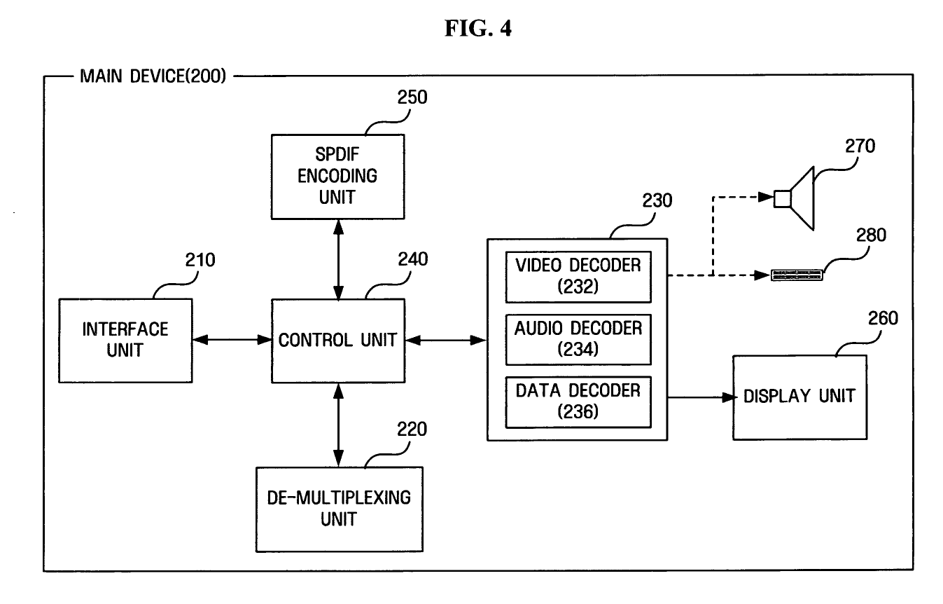

FIG. 4 is a block diagram illustrating a main device according to an embodiment of the present invention. As show in FIG. 4, the main device 200 comprises an interface unit 210, a de-multiplexing unit 220, a decoding unit 230, a control unit 240, and an SPDIF encoding unit 250.

The interface unit 210 is connected to the DMB receiver 100 and receives a demodulated DMB signal from the DMB receiver 100. The interface unit 210 may additionally transfer a control signal for channel tuning or transfer an audio signal for outputting to the DMB receiver 100. To this end, the interface unit 210 includes multiple signal transfer nodes for demodulated DMB signal reception, control signal transfer, or audio signal transfer.

The de-multiplexing unit 220 separates a video signal, an audio signal, and an additional information signal from the DMB signal, which the interface unit 210 received from the DMB receiver 100, by parsing the DMB signal, and then transfers the separated signals to the decoding unit 230.

The decoding unit 230 includes a video decoder 232 and an audio decoder 234 which decode the video signal and audio signal from the de-multiplexing unit 220, respectively. The video decoder 232 may be implemented according to a video compression/decompression scheme, such as Moving Picture Experts Group-2 (MPEG-2), MPEG-4, etc., and the audio decoder 234 may be implemented according to an audio compression/decompression scheme, such as MPEG Layer-3 (MP3), Audio Compression 3 (AC3), etc. The decoded video signal is displayed by a display unit 260, and the decoded audio signal is transferred to the SPDIF encoding unit 250 under the control of the control unit 240. However, according to user's preference, the decoded audio signal may also be either output through a speaker 270 or transferred to an earphone connection jack 280.

Additionally, the decoding unit 230 may include a data decoder 236 which decodes the additional information signal provided from the de-multiplexing unit 220. The additional information may include caption data, channel number, channel name, broadcasting data, broadcasting start time, etc., and may be displayed by the display unit 260.

The control unit 240 controls the operation of the main device 200. The control unit 240 generates the control information for channel tuning in response to a request from the user; the control unit 240 then transmits the generated control information to the interface unit 210. When the interface unit 210 is connected to the DMB receiver 100, the control unit 240 also controls the audio signal decoded by the decoding unit 230, transferring it to the SPDIF encoding unit 250. However, according to the user's preference, the control unit 240 may direct the audio signal to be transferred to the speaker 270 or the earphone connection jack 280. The interface unit 210 can determine if the DMB receiver 100 is connected to the main device or not, by receiving a signal reporting the connection/disconnection from the DMB receiver 100. Alternatively, the interface unit 210 may include a sensor unit (not shown) for detecting the connection of the DMB receiver 100, so that, using the sensor unit, it can determine if the DMB receiver 100 is connected or not.

The SPDIF encoding unit 250 generates an SPDIF signal by encoding the audio signal provided by the decoding unit 230 and then transfers the generated SPDIF signal to the interface unit 210.

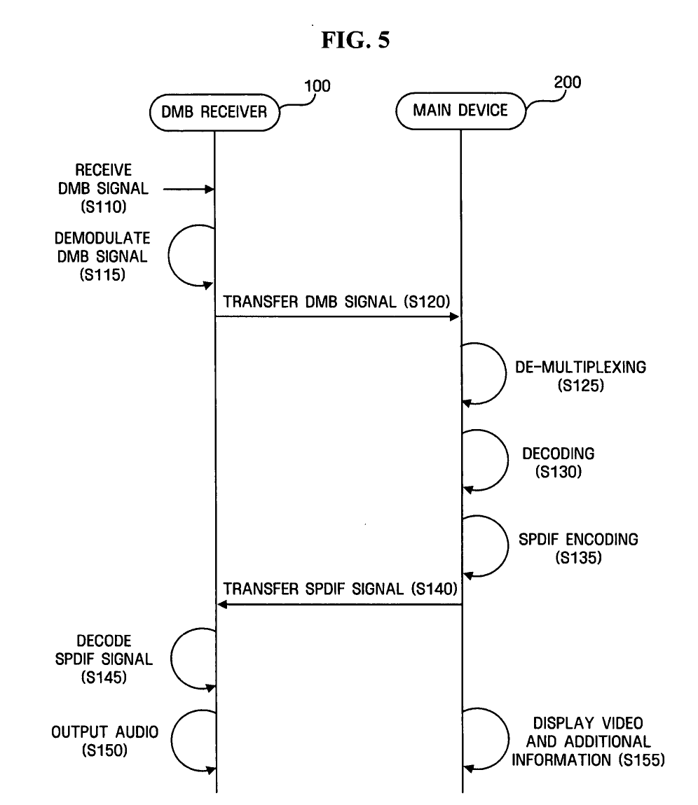

Hereinafter, a process between the DMB receiver 100 of FIG. 2 and the main device 200 of FIG. 3 will be described with reference to FIG. 5.

FIG. 5 is a flowchart illustrating a method for processing an audio signal between a DMB receiver and a main device according to an embodiment of the present invention.

First, when the receiving unit 110 of the DMB receiver 100 has received a DMB signal at operation S110, the processing unit 120 demodulates the received signal at operation S115. Then, the receiving unit 110 may down-convert the RF signal type DMB signal into an IF signal having a lower frequency, extract a baseband signal from the IF signal, and then transfer the extracted baseband signal to the processing unit 120. Further, the processing unit 120 may perform digital/analog conversion for the signal provided from the receiving unit 110, perform QPSK, and perform error correction according to an FEC scheme.

The DMB signal demodulated by the processing unit 120 is transferred through the interface unit 130 to the main device 200 at operation S120.

When the interface unit 210 of the main device 200 has received the demodulated DMB signal from the DMB receiver 100, the de-multiplexing unit 220 de-multiplexes the demodulated DMB signal, separating it into a video signal, an audio signal, and an additional information signal at operation S125.

Then the decoding unit 230 decodes the video signal, audio signal, and additional information signal at operation S130. The decoded video signal and additional information signal can be displayed to the user by the display unit 260 at operation S155.

The decoded audio signal is encoded by the SPDIF encoding unit 250 at operation S135 and is then transferred to the DMB receiver 100 through the interface unit 210 at operation S140. However, according to the user's preference, the audio signal may be transferred to the speaker 270 or the earphone connection jack 280 of the main device 200.

When the interface unit 130 of the DMB receiver 100 has received the SPDIF signal from the main device 200, the SPDIF decoding unit 142 decodes the SPDIF signal at operation S145. For example, the SPDIF decoding unit 142 can generate left/right audio signals and a low tone audio signal by decoding the SPDIF signal.

Thereafter, the audio signals generated by the SPDIF decoding unit 142 is output by the speakers 144 and 146 and the woofer 148 output the decoded audio signals to the user at operation S150.

According to another embodiment of the present invention, it is possible for the main device 200 not to include the SPDIF encoding unit 250 and the main device 200 may transfer the audio signals decoded by the decoding unit 230 directly to the DMB receiver 100. In this embodiment, operations S135 and S145 may be omitted from the flowchart of FIG. 5, and the interface unit 210 of the main device 200 directly transfers the decoded audio signals to the DMB receiver 100. In this embodiment the speakers 144 and 146 and the woofer 148 of the DMB receiver 100 can output the audio signals directly after receiving them from the main device 200.

The embodiments described above with reference to FIGS. 2 and 5 relate to a DMB receiver 100 having an embedded speaker and a main device 200 corresponding to the DMB receiver 100. Hereinafter, a DMB receiver 100 having an embedded battery and a main device 200 corresponding to the DMB receiver 100 will be described.

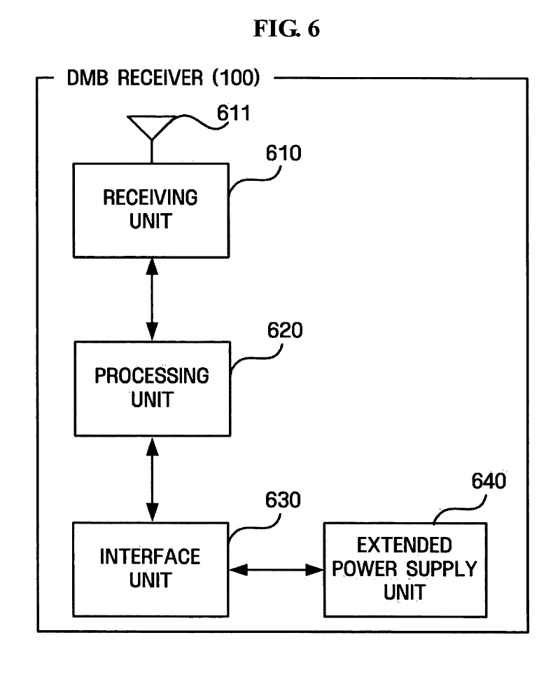

FIG. 6 is a block diagram illustrating a DMB receiver according to another embodiment of the present invention. As shown in FIG. 6, the DMB receiver 100 comprises a receiving unit 610, a processing unit 620, an interface unit 630, and an extended power supply unit 640.

The receiving unit 610, the processing unit 620, and the interface unit 630 shown in FIG. 6 are the same functional blocks as the receiving unit 110, the processing unit 120, and the interface unit 130 shown in FIG. 2.

The extended power supply unit 640 supplies electric power to the receiving unit 610, the processing unit 620, and the interface unit 630. In addition, the extended power supply unit 640 supplies electric power to the main device 200 when the interface unit 630 is connected to the main device 200. The extended power supply unit 640 may be implemented by a battery including a lithium polymer. The extended power supply unit 640 has nodes for charge or discharge of electricity and its charge or discharge is controlled by a charge/discharge chip installed in the main device 200.

Since the interface unit 630 is connected to the extended power supply unit 640, the interface unit 630 serves as a medium, which transfers to the extended power supply unit 640 a control signal for the electric power from the main device 200 and transfers a power signal generated in the extended power supply unit 640 to the main device 200. Therefore, when the interface unit 630 is connected to the main device 200, the extended power supply unit 640 can operate as a power source for the main device 200. Before the DMB receiver 100 is connected to the main device 200, the battery of the main device 200 supplies electric power. However, after the DMB receiver 100 is connected to the main device 200, the extended power supply unit 640 of the DMB receiver 100 supplies power to the main device 200, so that the power of the extended power supply unit 640 is first consumed.

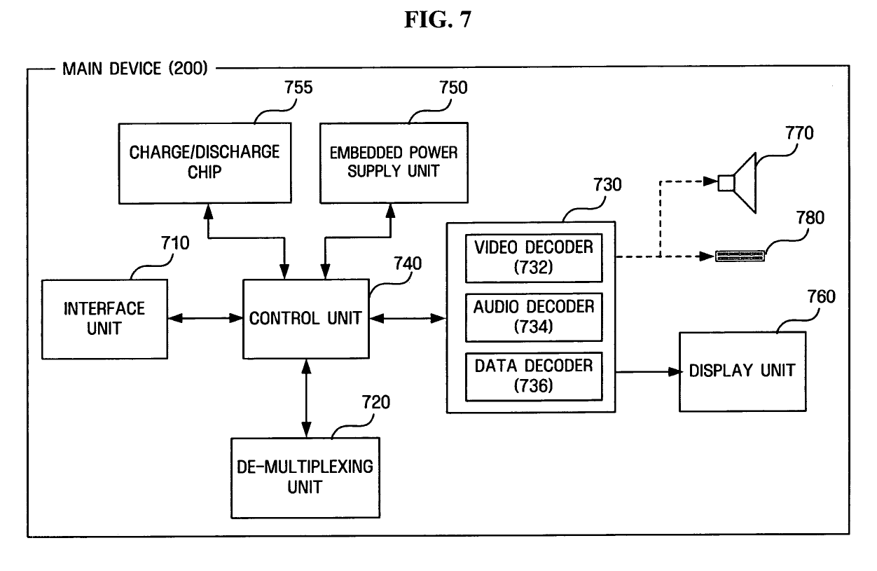

FIG. 7 is a block diagram illustrating a main device corresponding to the DMB receiver described with reference to FIG. 6. As shown in FIG. 7, the main device 200 comprises an interface unit 710, a de-multiplexing unit 720, a decoding unit 730, a control unit 740, an embedded power supply unit 750, and a charge/discharge chip 755.

The functions of the interface unit 710, the de-multiplexing unit 720, the decoding unit 730, and the control unit 740 are similar to those of the interface unit 210, the de-multiplexing unit 220, the decoding unit 230, and the control unit 240 described above with reference to FIG. 4.

The embedded power supply unit 750 is a power supply unit, which is embedded in, and supplies electric power to, the main device 200. When the main device 200 is connected to the DMB receiver 100, the electric power of the extended power supply unit 640 mounted in the DMB receiver 100 may be first consumed under the control by the control unit 740 while the embedded power supply unit's 750 charge is conserved.

The charge/discharge chip 755 charges electricity into or discharges electricity from the embedded power supply unit 750 and the control unit 740. When the interface unit 710 is not connected to the DMB receiver 100, the control unit 740 directs the embedded power supply unit 750 to supply electric power to the main device 200. When the interface unit 710 is connected to the DMB receiver 100, the control unit 740 directs the extended power supply unit 640 in the DMB receiver 100 to supply electric power to the main device 200. That is, when the connection between the main device 200 and the DMB receiver 100 is established, the power supply source is switched from the embedded power supply unit 750 of the main device 200 to the extended power supply unit 640 of the DMB receiver 100.

According to another embodiment of the present invention, the DMB receiver 100 may include both the audio output unit 140 described above with reference to FIG. 2 and the extended power supply unit 640 described above with reference to FIG. 6. In this case, the main device 200 has a structure corresponding to such a DMB device 100, description of which is omitted here because it can be easily conceived from the above-described embodiments.

As used herein, the “unit” for indicating functional blocks of the DMB receiver 100 and the main device 200 can be implemented by a type of module. The “module” refers to a software element or a hardware element, such as a Field Programmable Gate Array (FPGA) or an Application Specific Integrated Circuit (ASIC), which performs a predetermined function. The module may be constructed to reside in an addressable storage medium or to execute one or more processors. Therefore, the module includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the modules may be either combined into a smaller number of elements or modules or divided into a larger number of elements or modules.

Software modules can be written via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An apparatus for receiving digital multimedia broadcasting, comprising:
a receiving unit which receives a digital multimedia broadcasting signal;
a processing unit which demodulates the received digital multimedia broadcasting signal;
an interface unit which transfers the demodulated digital multimedia broadcasting signal to a main device and receives an audio signal from the main device; and
an audio output unit which outputs the received audio signal.

2. The apparatus of claim 1, wherein the audio output unit comprises one or more speakers.

3. The apparatus of claim 1, wherein the audio signal received from the main device is a Sony/Philips Digital Interface signal, and the audio output unit further comprises a Sony/Philips Digital Interface decoding unit to decode the Sony/Philips Digital Interface signal.

4. The apparatus of claim 1, wherein the audio signal received by the interface unit from the main device is a signal which the main device has extracted from the digital multimedia broadcasting signal.

5. A method of outputting audio by an apparatus for receiving digital multimedia broadcasting, comprising:
demodulating a received digital multimedia broadcasting signal;
transferring the demodulated digital multimedia broadcasting signal to a main device;
receiving an audio signal from the main device; and
outputting the received audio signal.

6. The method of claim 5, wherein the audio signal received by the interface unit from the main device is generated by extracting it from the digital multimedia broadcasting signal.

7. The method of claim 5, wherein the received audio signal is a Sony/Philips Digital Interface signal, and is output after decoding the Sony/Philips Digital Interface signal.

8. An apparatus for receiving digital multimedia broadcasting, comprising:
a receiving unit which receives a digital multimedia broadcasting signal;
a processing unit which demodulates the received digital multimedia broadcasting signal;
an interface unit which transfers the demodulated digital multimedia broadcasting signal to a main device; and
an extended power supply unit which supplies electrical power to the main device.

9. The apparatus of claim 8, wherein the interface unit comprises a sensor unit that detects connection to the main device and reports the connection to the main device.

10. The apparatus of claim 8, wherein the extended power supply unit operates as a power source for supplying electrical power to the main device when a connection to the main device is established.

11. A system for receiving digital broadcasting, comprising:
a receiving apparatus which receives a digital media broadcast signal; and
a main device which transfers an operation command input by a user to the digital multimedia broadcast receiving apparatus, and receives and outputs the broadcasting signal received by the digital multimedia broadcast receiving apparatus, wherein the digital multimedia broadcast receiving apparatus includes:
a receiving unit that receives the digital media broadcast signal;
a processing unit which converts the digital media broadcast signal received by the receiving unit to a digital signal;
an interface unit which connects the receiving apparatus to a main device and transfers the digital signal from the processing unit to the main device; and
an extended power supply unit which supplies electric power to a main device.

12. The system of claim 11, wherein the main device comprises:
a decoding unit which decodes the digital signal transferred from the digital multimedia broadcast receiving apparatus;
a display unit which displays the broadcast video signal decoded by the decoding unit;
an embedded power supply unit which supplies electric power to the main device;
an interface unit which is connected to the digital multimedia broadcast receiving apparatus; and
a control unit which controls the decoding unit, the display unit, and the embedded power supply unit, and controls the extended power supply unit through the interface unit.

13. The system of claim 12, wherein the control unit causes the embedded power supply unit to supply electrical power to the main device if the digital multimedia broadcast receiving apparatus and the main device are not connected, and causes the extended power supply unit to supply electric power to the main device if the digital multimedia broadcast receiving apparatus and the main device are connected.

14. The apparatus of claim 1, further comprising an extended power supply unit which supplies electrical power to the main device.

15. The apparatus of claim 8, further comprising:
an interface unit which receives an audio signal from the main device an audio output unit which outputs the received audio signal, via one or more speakers.

16. A mobile device comprising:
a controller arranged to control operation of the mobile device; and
a broadcast receiver detachably connected to the controller, via an interface unit, and arranged to generate and output a processed signal to the controller, via the interface unit, the broadcast receiver comprising a power source for supplying electric power to the mobile device.

17. The mobile device of 16, further comprising:
a de-multiplexer arranged to separate the processed signal into video, audio, and information signals; and
the broadcast receiver further comprising one or more speakers, and being configured to output the audio signal, via the one or more speakers.
